(19) United States
(12) Patent Application Publication
(10) Pub. No.: US 2007/0280075 A1
(43) Pub. Date: Dec. 6, 2007

(54) Disc Recording/Playback Device, Media Recording/Playback Device and Data Recording/Playback Method

(76) Inventor: Kenji Akahoshi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/747,399

(22) Filed: May 11, 2007

(30) Foreign Application Priority Data
Jun. 6, 2006 (JP) 2006-156756

(51) Int. Cl. G11B 27/36

(52) U.S. Cl. 369/53.31; 369/47.32

(57) ABSTRACT

In copying data of a plurality of optical discs into a single optical disc through a buffering unit without temporarily saving the data in an external recording unit, a method is provided which increases a time available for the user to select data after disc exchange without increasing a buffer capacity. After the buffering of the disc 1 is completed until the user finishes selection of data to be transmitted, i.e., the disc 2 begins to be buffered, an instruction is issued to lower the data transfer rate to the external disc recording/playback device below the one before the disc 1 is extracted and to lower the speed at which to write the data of the disc 2 into the external disc recording/playback device below the one before the disc 1 is extracted.

### INCORPORATION BY REFERENCE

The present application claims priority from Japanese application JP2006-156756 filed on Jun. 6, 2006, the content of which is hereby incorporated by reference into this application.

### BACKGROUND OF THE INVENTION

1. Field of the Invention

The present invention relates to a recording/playback device and a data recording/playback method and more particularly to a process of reading data from a media loaded in the recording/playback device and sending the data to an external recording/playback device for recording.

2. Description of the Related Art

To transfer data from a plurality of discs continuously to another disc, a method is available that provides the transfer source discs with a buffer means to save the data in the buffer means before transferring it. This method allows data to be transferred without using an external storage device, such as a hard disk drive, as an intermediate device. This is described in JP-A-8-7380.

### SUMMARY OF THE INVENTION

Among removable disc recording/playback devices to be connected to personal computers and recorders are optical recording/playback devices, such as CD (Compact Disc) drives, DVD (Digital Versatile Disc) drives and Blu-ray drives.

As a video camera incorporating this optical recording/playback device, a DVD video camera that records and plays a 8-cm recordable DVD disc is already on the market. In copying data of a plurality of optical discs recorded by a DVD video camera into another optical disc, one of available methods involves copying all the data into a recording area, such as a hard disk incorporated in a personal computer, and then transferring the data to the destination optical disc at a time. This is described in a non-patent document 1: Hitachi Ltd., “DZ-Gx20/MV780(S)/(R)/(A) type Hitachi DVD Video Camera Instruction Manual” 2004.

To create a recordable DVD media with high playback compatibility so that the copied disc can be played in DVD players or others requires recording the data into the media with no gaps or junctions between pieces of data. Although provisions are made to ensure that errors which may occur at junctions between pieces of written data can be corrected, there is no guarantee that the copied data can be read in any type of drive (see a non-patent document 2: Nikkei BP Soft Press “DVD Re-Learned Systematically”, June, 2003).

Here, the process of linking in a DVD-R/RW (DVD-Recordable/Rerecordable Disc) will be explained by referring to FIG. 4.

To improve data reliability at time of linking, the DVD-R/RW is provided with a linking loss area. Three linking loss areas are defined—32 KB (Kilo Byte), 2 KB and 0 KB. Denoted 401 is a 32-KB link in which additional data is recorded following 32 KB (16 sectors) of padding data (0 data). Denoted 402 is a 2-KB link in which additional data is recorded following 2 KB (1 sector) of padding data (0 data). Denoted 403 is a 0-KB link, also called a lossless link, in which additional data is recorded with no preceding 2-KB (1 sector) padding data (0 data). (See a non-patent document 3: ECMA Standard ECMA-338 80 mm (1.46 Gbytes per side) and 120 mm (4.70 Gbytes per side) DVD Re-recordable Disk (DVD-RW)). It is noted, however, that not all recordable type devices are compatible with the DVD-R/RW lossless linking. Generally, when additional data is appended, 2-32 KB of joint is produced. Some DVD players may not be able to pass this joint, failing to read data or producing noise.

Let us consider a case where a buffering means is used and a user transfers data from a plurality of discs into another disc by exchanging the discs. For example, when recording all data of two different discs (disc 1 and disc 2) into one disc, since what is needed is to transfer all data of the disc 1 and the disc 2, there is no need to select data from the source discs. This means that, when the data buffering of the disc 1 is completed, the user needs only to replace the disc 1 with the disc 2 and to continue buffering data of the disc 2. After the disc exchange, there is no work that should be performed on the part of the user. On the other hand, when an original video footage shot with a DVD camera or a TV program is to be copied, only those portions of the data in the discs need to be copied. In copying the disc 1 there is no time limitation since the data buffering is not yet started. In the copying of the second or subsequent discs, it is necessary to complete a selection of scenes that the user wants recorded before the buffered data runs out so as to prevent the data recording to the disc from being interrupted. An issue to be considered here is a time that can be selected by the user. Increasing the data capacity to be buffered delays a timing when the data in the buffer runs out, giving more time to the user. However, an increase in the buffer capacity leads to a cost increase, so the buffer capacity cannot be increased indiscriminately.

It is therefore an object of this invention to copy data of a plurality of optical discs into at least one optical disc in a recording/playback device such as a DVD video camera. This object can be realized by what is described in the scope of claims. This invention allows for the copying of data convenient for the user.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a configuration of a system to transmit data from a plurality of discs to a single disc (embodiment 1).

FIG. 2 is a flow chart 1 showing a sequence of steps to transmit data from a plurality of discs to a single disc.

FIG. 3 is a flow chart 2 showing a sequence of steps to transmit data from a plurality of discs to a single disc.

FIG. 4 is an explanatory diagram showing linking areas used in writing on DVD-R/RW discs.

FIG. 5 is a block diagram showing a configuration of a system to transmit data from a plurality of discs to a single disc (embodiment 2).

### DESCRIPTION OF THE EMBODIMENTS

Now, embodiments of this invention will be described by referring to the accompanying drawings.

### 1. Embodiment 1

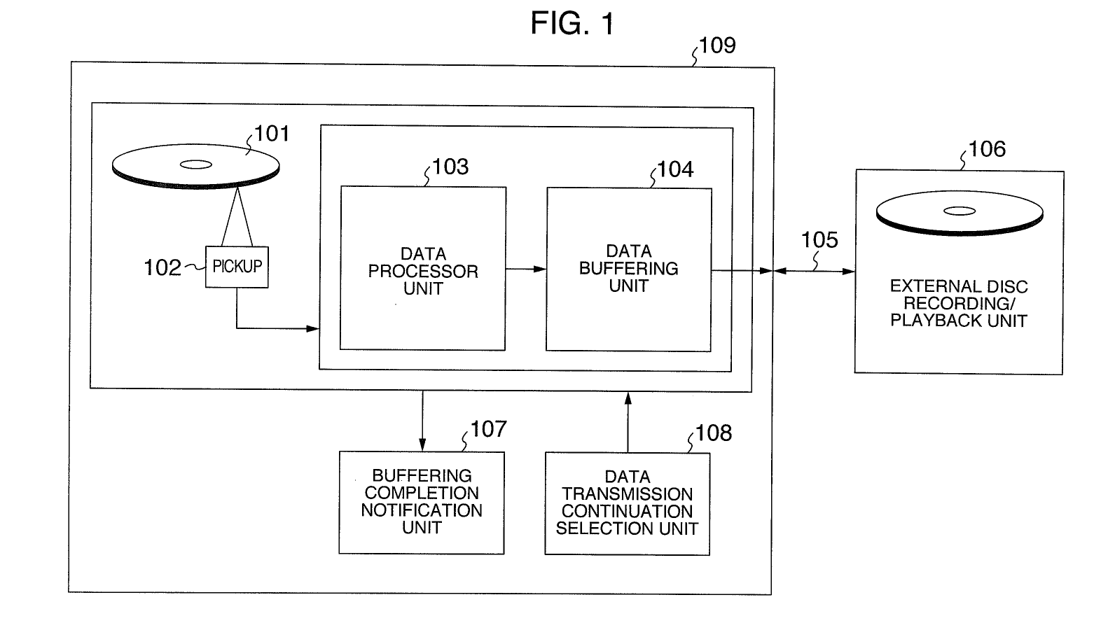

FIG. 1 is a block diagram showing a configuration of a disc recording/playback device in which a reference 109 represents a DVD video camera that records and plays a removable disc. Although components of the camera, such as lens and video processing unit, are not shown here, the camera of course has all constitutional elements necessary to record videos in a DVD. Denoted 106 is an external disc recording/playback unit connected to the DVD video camera 109 to record data transferred from the DVD video camera 109. In this embodiment this external disc recording/playback unit 106 is a DVD recorder.

Denoted 101 is a disc to be played, 102 a pickup to read data recorded in the disc 101, 103 a data processor unit that performs decoding, error correction and other processing required in outputting data, and 104 a data buffering unit installed between the data processor unit 103 and the DVD recorder 106 to buffer the data output from the data processor unit 103 before sending it to the DVD recorder 106.

Denoted 105 is an interface signal between the DVD video camera 109 and the DVD recorder 106. A reference number 107 represents a buffering end notification unit to notify the user that the buffering of the data of the disc loaded in the DVD video camera 109 is finished. A reference number 108 represents a data transmission continuation selection unit that, when the data transfer of one disc is finished, makes a decision as to whether the data transfer should be ended or continued after exchanging the disc.

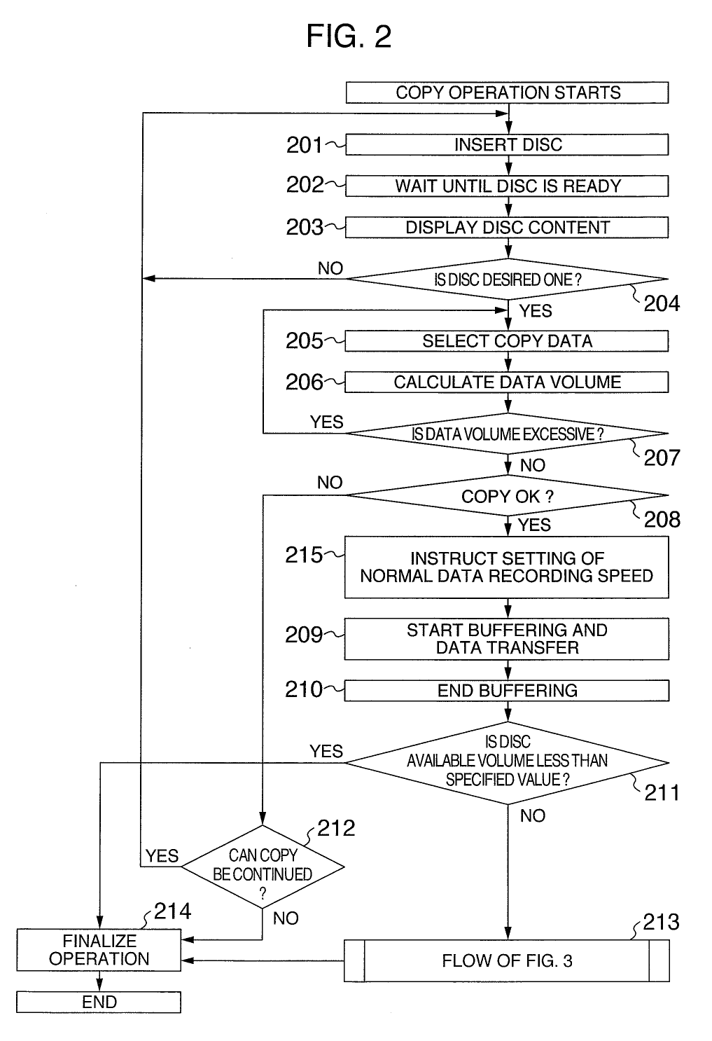

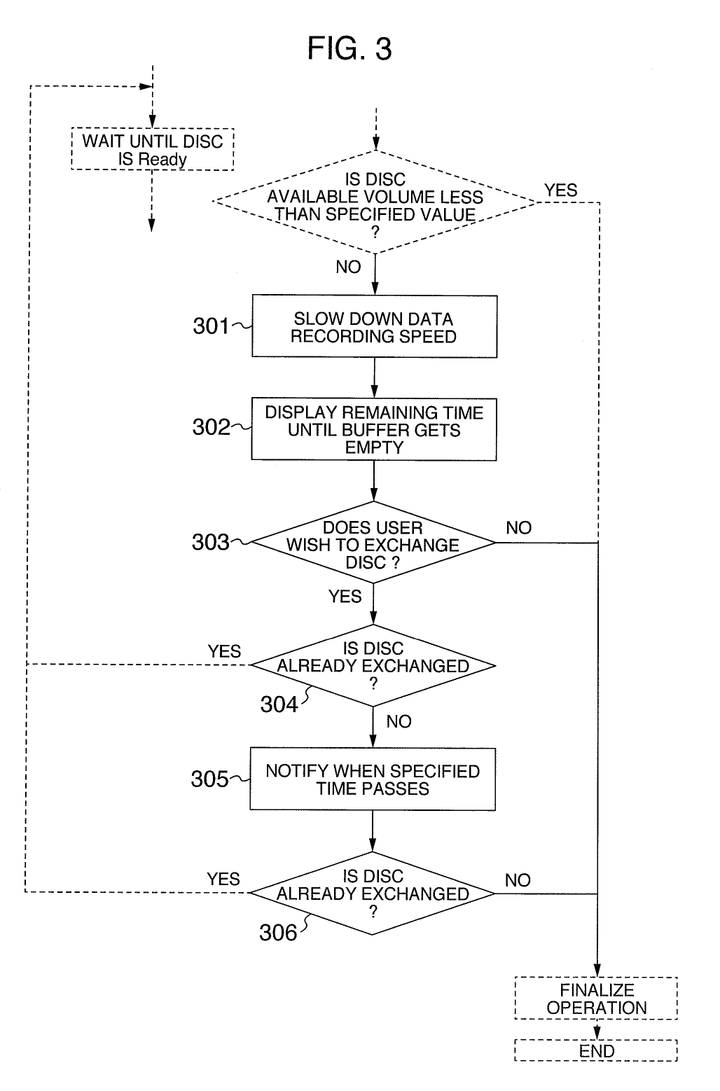

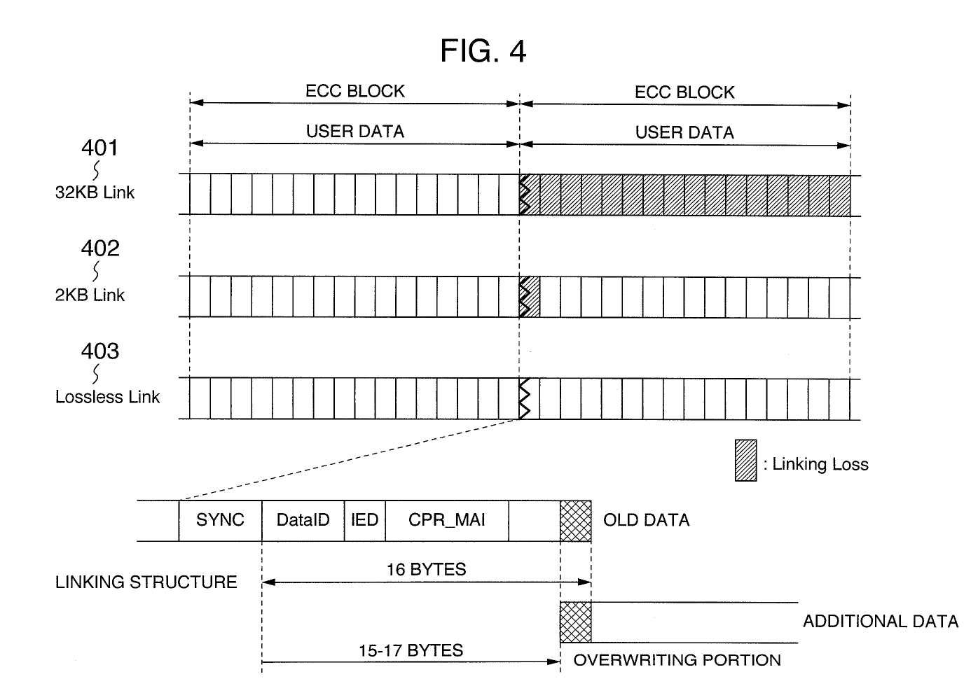

Now an example case of copying a plurality of 8-cm DVD discs (two in this example) into a 12-cm DVD disc will be described by referring to FIG. 1, FIG. 2, FIG. 3 and FIG. 4.

Two 8-cm DVD discs as a copy source are referred to as a disc 1 and a disc 2, respectively, and a 12-cm DVD disc as a copy destination is referred to as a disc 3.

First, the disc 1 or disc 101 is loaded (step 201) and the processing waits until the disc is ready to be played (step 202). When the disc is ready, the content of video in the disc is displayed in thumbnail (step 203). The display of thumbnail images allows the user to visually check whether the disc loaded is the one he wants. This helps prevent unwanted discs from being copied especially when the disc carries no title label. If the disc is found to be the one he wants, the processing proceeds to a step of selecting video data to be copied. If not, the processing moves back to a step of choosing a desired disc (step 204).

If the disc is the desired one, the user selects thumbnail-displayed video data to be copied (step 205), the total volume of the data selected is calculated (step 206), and a decision is made as to whether the selected video data can be copied into a destination disc 3 (step 207). If the data volume exceeds the available capacity, the copy data is selected again. If not, the user is prompted to acknowledge the start of copying (step 208). Now, the transfer of data to the DVD recorder and the data buffering are started (step 209).

The data buffering unit 104 does not need to have a large enough capacity to buffer all the selected data in the disc 1 but is only required to be able to buffer a volume of video data equivalent to the time length that allows the user to exchange the disc and select video data. The data volume changes depending on the size and image quality of the video data and the increased buffer capacity results in an increase in the cost of the data buffering unit. So, the buffer capacity may be determined based on system specifications and this example does not specify any particular buffer capacity. Data is buffered in an FIFO (First-In First-Out) mode. The data buffered first is sent to the DVD recorder for recording. As an indication of the time the buffering will take until the next disc exchange, the time up to the end of the buffering may be displayed to the user.

When data transmission to the data buffering unit 104 is completed (step 210), a check is made as to whether the disc 3 has a sufficient area available for recording (step 211). If it is determined that the disc 3 has an available area but not in a sufficient volume to allow the video data to be written into, the finalize operation is performed on the disc 3 (to prohibit the disc from being written in order to make it playback-compatible) (step 214).

If it is decided that the disc 3 can be written into, the data transfer end processing is not executed but the subsequent flow of processing in FIG. 3 continue to be executed (step 213). Next, the steps of FIG. 3 will be explained.

The time it takes from when the buffering of the disc 1 has been finished until the data transfer from the data buffering unit 104 to the DVD recorder is completed is the time during which the data can be recorded without producing a linking area between the disc 1 data and the disc 2 data, i.e., without causing a buffer empty error.

Therefore, during this period the user needs to exchange the disc for the next disc 2, select data to be copied and start the copying of the disc 2 (start buffering).

To secure as much time as possible for the user to replace disc and select data, two operations are executed when the buffering of the disc 1 is finished. The first operation is to lower the rate of data transfer from the data buffering unit to the DVD recorder. Because the rate at which the data is taken out from the data buffering unit is lowered, the time it takes for the buffer to be emptied of the data becomes longer, securing an increased time for the user. Alternatively, the data buffering rate may be increased and the data transfer lowered.

The second operation is to issue an instruction to the DVD recorder to set the speed at which to write the disc 3 to the lowest recording speed of the DVD recorder (step 301). Suppose, for example, the ordinary data recording speed is a 2× speed (double speed). During the disc exchange, the recording speed is lowered to 1× speed to reduce the rate at which data is pulled out of the buffer, which in turn prolongs the time it takes for the buffer to be emptied of the data, contributing to securing more time for user action. That is, the speed at which to transmit data to the DVD recorder needs only to be faster than the recording speed of the DVD recorder. Therefore, the second operation may be to increase the data transfer rate to the DVD recorder.

Further, a remaining time for the user to replace the disc and select video data is displayed to urge the user to perform the disc exchange and data selection (step 302).

When the data buffering unit 104 completes the data transmission of the disc 1, the user can decide whether or not to exchange the disc (step 303).

If the user chooses not to exchange the disc, the finalize operation is executed. If the user chooses to exchange the disc, the processing enters a disc exchange waiting state (step 304) and, when the disc is replaced, the same flow of processing as with the disc 1 will be executed. Just before starting to transmit data to the data buffering unit, an instruction is issued to return the data transfer rate to the DVD recorder and the disc recording speed to the original ones (step 215).

When the remaining data volume in the buffer runs low because the user does not exchange the disc or because the user takes time selecting data, the user is given another warning (step 305). At this time, the user may be alerted as by screen display, warning sound or voice guidance. If the disc exchange or data selection is not performed by the time the disc exchange time limit is reached, the processing automatically proceeds to the finalize operation.

As described above, the present invention makes it a precondition that the disc exchange and data selection on the part of the user be completed before the buffer runs out of data. With this precondition met, the invention enables data to be transferred from a plurality of discs to a single disc without temporarily saving the data in a hard disc drive of the DVD recorder 106 and without producing any linking area.

### 2. Embodiment 2

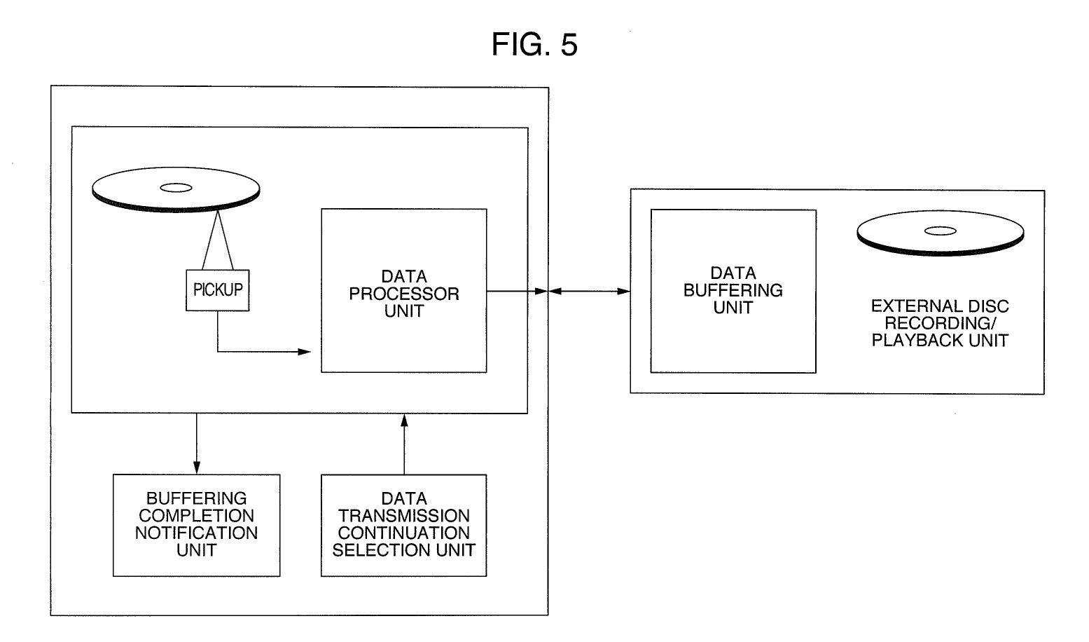

Next, a second embodiment of this invention will be explained by referring to FIG. 5.

FIG. 5 represents a case where the data buffering unit of FIG. 1 is provided in the DVD recorder. The only difference between the first and second embodiment is which of the devices performs the buffering of the data to be recorded. So, the similar effects to those of the first embodiment can also be produced in this embodiment.

Since the second embodiment has the data buffering unit installed on the DVD recorder side, the data recording speed in the DVD recorder may be instructed to be reduced, rather than lowering the data transfer rate to the DVD recorder as in the first embodiment. That is, the only requirement is to set the rate of buffering the data in the data buffering unit of the DVD recorder and the rate of data transmission to the DVD recorder faster than the data recording speed of the DVD recorder.

In either embodiment, by slowing down the operation of drawing data out of the data buffering unit, more time can be made available to the user during the disc exchange.

Further, while both of the embodiment 1 and 2 have taken up the 8- and 12-cm DVDs in the example explanations, it is of course possible to apply other optical discs than DVD-R/RW, such as next generation Blue-ray and HD DVD, and produce the similar effects.

Although the above embodiments have described the discs as an example, this invention can also be applied to any recording media that can record data, such as semiconductor memory, with the similar effects produced.

Further, while the above embodiments use the video camera as the device on the playback side and the DVD recorder as the external disc recording/playback unit, the use of other recording/playback devices can also produce the similar effects as long as the devices used have the same functions as explained above.

It should be further understood by those skilled in the art that although the foregoing description has been made on embodiments of the invention, the invention is not limited thereto and various changes and modifications may be made without departing from the spirit of the invention and the scope of the appended claims.

1. A disc recording/playback device for recording data in a removable disc and for playing the recorded data, comprising:
a data buffering unit for buffering data of a firstly loaded disc 1; and
a data transmission unit for transmitting the data to an external disc recording/playback device connected to the disc recording/playback device;
wherein the data buffering unit can continue the data buffering of the disc 1 and a disc 2 if a disc exchange is done by removing the disc 1 and inserting the disc 2;
wherein the data transmission unit can transmit without interruption the data of the disc 1 and the data of the disc 2, both buffered continuously, by lowering a data transfer rate during the disc exchange below a data transfer rate during the data buffering of the discs or lowering the data transfer rate below a data buffering speed of the discs.

2. A disc recording/playback device for recording data in a removable disc and for playing the recorded data, comprising:
a data transmission unit for transmitting the data to an external disc recording/playback device connected to the disc recording/playback device;
wherein the data transmission unit can continue the data transmission of a disc 1 and a disc 2 if a disc exchange is done by removing the disc 1 and inserting the disc 2;
wherein the data of the disc 1 and the data of the disc 2 can be recorded in the external disc recording/playback device without interruption by raising a data transfer rate of the data transmission unit above a data buffering speed of a buffering unit in the external disc recording/playback device or above a data recording speed in the external disc recording/playback device.

3. A disc recording/playback device according to claim 1, further including a buffering completion notification unit to notify the user of a completion of reading the data of the disc 1 into the data buffering unit.

4. A disc recording/playback device according to claim 3, further including a display unit to indicate a disc exchange time limit after the completion of the data buffering of the loaded disc 1.

5. A disc recording/playback device according to claim 4, wherein the disc exchange time limit is the time it takes for the buffered data of the disc 1 to be completely transmitted to the external disc recording/playback device.

6. A disc recording/playback device according to claim 4, wherein the disc exchange time limit is a time subtracted a preparation time from the time it takes for the buffered data of the disc 1 to be completely transmitted to the external disc recording/playback device, the preparation time being the time it takes a disc 2 that has replaced the disc 1 to be able to be played.

7. A disc recording/playback device according to claim 4, wherein if the disc exchange time limit following the completion of the buffering of the data of the disc 1 loaded in the disc recording/playback device becomes less than a predetermined length of time, the display unit notifies the user that a remaining time available for the user is short.

8. A disc recording/playback device according to claim 4, wherein if a specified time has passed from when the disc exchange time limit following the completion of the buffering of the data of the loaded disc 1 becomes less than a predetermined length of time, a finalize operation is performed on a disc loaded in the external disc recording/playback device.

9. A disc recording/playback device according to claim 3, wherein, following the completion of the buffering of the data of the loaded disc 1, the user can decide whether or not to transmit the data of the disc 2.

10. A disc recording/playback device according to claim 3, wherein if, following the completion of the buffering of the data of the loaded disc 1, the user decides not to transmit the data of the disc 2, a finalize operation is performed on a disc loaded in the external disc recording/playback device.

11. A media recording/playback device for recording data in a removable media and for playing the recorded data, comprising:
a data buffering unit for buffering data of a first loaded media; and
a data transmission unit for transmitting the data to an external recording/playback device connected to the media recording/playback device;
wherein the data buffering unit can continue the data buffering of the first media and the second media if a media exchange is done by removing the first media and inserting the second media;
wherein the data transmission unit can transmit without interruption the data of the first media and the data of the second media, both buffered continuously, by lowering a data transfer rate during the media exchange below a data transfer rate during the data buffering of the media or lowering the data transfer rate below a data buffering speed of the media.

12. A data recording/playback method for playing data of removable discs in a disc recording/playback device, transmitting the data to an external disc recording/playback device connected to the disc recording/playback device and recording the data in the external disc recording/playback device, the method comprising the steps of:
buffering data of a disc 1 loaded in the disc recording/playback device and then transmitting the data to the external disc recording/playback device; and
after completion of the buffering of the data of the disc 1 loaded in the disc recording/playback device, replacing the disc 1 loaded in the disc recording/playback device with the disc 2;
wherein the buffering continuously buffers the data of the disc 2 following the data of the disc 1 to allow these data to be transmitted to the external disc recording/playback device continuously;
wherein the data transmission transmits without interruption the data of the disc 1 and the data of the disc 2, both buffered continuously, by lowering a data transfer rate during the disc exchange below a data transfer rate during the data buffering of the discs or lowering the data transfer rate below a data buffering speed of the discs.

13. A data recording/playback method for playing data of removable discs in a disc recording/playback device, transmitting the data to an external disc recording/playback device connected to the disc recording/playback device and recording the data in the external disc recording/playback device, the method comprising the steps of:
transmitting data of a disc 1 loaded in the disc recording/playback device to the external disc recording/playback device;
replacing the disc 1 loaded in the disc recording/playback device with the disc 2; and
transmitting the data of the disc 1 and the data of the disc 2 continuously;
wherein the data of the disc 1 and the data of the disc 2 can be recorded in the external disc recording/playback device without interruption by raising a data transfer rate of a data transmission unit above a data buffering speed of a buffering unit in the external disc recording/playback device or above a data recording speed in the external disc recording/playback device.
